(19) United States
(12) Patent Application Publication
(10) Pub. No.: US 2010/0087954 A1
(43) Pub. Date: Apr. 8, 2010

(54) ROBOT AND ROBOT CONTROL SYSTEM

(76) Inventors: Min-Wei Chung, Taipei County (TW); Sung-Tsun Chou, Hsin Chu County (TW)

Correspondence Address: Muncy, Geissler, Olds & Lowe, PLLC, P.O. BOX 1364, FAIRFAX, VA, 22038-1364, US

(21) Appl. No.: 12/483,866

(22) Filed: Jun. 12, 2009

(30) Foreign Application Priority Data
Oct. 6, 2008 (TW) 097138358

(51) Int. Cl. G06F 19/00; G06F 7/00; G05B 19/00

(52) U.S. Cl. 700/245

(57) ABSTRACT

An embodiment of the present invention provides a robot suitable for receiving an input signal to generate a response. The input signal includes a tone provided with a command and having a first frequency. The robot includes a receiver, a signal processor, a driver and a response device. The receiver receives the tone of the input signal. The signal processor acquires a command by determining whether the first frequency satisfies a predetermined relationship. The driver generates an operation signal according to the command. The response device receives the operation signal and generates the response according to the operation signal.

### BACKGROUND OF THE INVENTION

(a) Field of the Invention

The invention relates to a robot and a robot control system, particularly to a robot using a tone and a robot control system using a tone to control.

(b) Description of the Related Art

FIG. 7 shows a conventional toy and the functional block diagram thereof. The toy 900 comprises a driver 920 and a plurality of response devices. The response device 940 can generate arm motions. The driver 920 electrically couples to the response device 940 and the response device 940 is controlled by the driver 920 to generate a response. The response can be an arm motion, such as waving or knocking. The response device 940 can comprise a motor module 942 electrically coupling to the driver 920 and an arm module 943 connected to the motor module 942. The response device 940 can use a motion module instead of the arm module 943 to generate a motion. For example, a foot module to advance a step or an eye module to blink eyes can be used instead of the arm module 943. The response device can also comprise a lighting module 942a and the response can be the variation of the light from the lighting module 942a. The response device can also comprise a sound module 942b of a loud-speaker 943b and the response is the different sound produced by the loud-speaker 943b.

Currently, a commercial toy usually has only one single motion with no compound motion. Besides, such toy does not have enough diverse applications. That is to say, the commercial toy usually has one or a certain number of built-in songs and executes a preset motion according to the built-in program. Therefore, the commercial toy can not interact with human beings and bores human beings along with the increase of using time.

### BRIEF SUMMARY OF THE INVENTION

One embodiment of the invention is to provide a robot suitable for receiving an input signal to generate a response where the input signal includes a tone that comprises a first frequency. The robot includes a receiver, a signal processor, a driver and a response device. The receiver receives the tone of the input signal. The signal processor acquires a command by determining whether the first frequency satisfies a predetermined relationship. The driver generates an operation signal according to the command. The response device receives the operation signal and generates the response according to the operation signal. In one example, the response can be an arm motion, foot stepping, eye blinking, sound uttering, light, etc.

Another embodiment of the invention is to provide a robot control system, comprising a storage unit, a playing device, a receiver, a signal processor, a driver, and a response device. The receiver, the signal processor, the driver, and the response device can be components of a robot. The storage unit stores at least one audio signal. The audio signal comprises a tone and the tone comprises a first frequency. The playing device accesses the audio signal and plays the audio signal. The receiver receives the tone of the audio signal. The signal processor acquires a command by determining whether the first frequency satisfies a predetermined relationship. The driver generates an operating signal according to the command. The response device receives the operating signal and thereby generates a response according the operating signal. The response is substantially related to the content of the audio signal. In one example, the storage unit is an optical disc and the playing device is an optical disc player.

Furthermore, another embodiment of the invention is to provide a robot control system, comprising a storage unit, an input device, a tone processing unit, a receiver, a signal processor, a driver, and a response device. The receiver, the signal processor, the driver, and the response device can be components of a robot. The input device is used to input a control datum. The storage unit stores a plurality of audio signals that are all different where each audio signal comprises a tone and each tone has a command and comprises a first frequency. The tone processing unit analyzes the relation between the control datum and the commands in the tones to generate a selecting audio signal corresponding to the control datum. The receiver receives the selecting audio signal. The signal processor acquires the command of the selecting audio signal by determining whether the first frequency satisfies a predetermined relationship. The driver generates an operating signal according to the command. The response device receives the operating signal and thereby generates a response according the operating signal. The response is substantially related to the content of the audio signal.

In one example, in the above robot and the robot control system, the tone further comprises a second frequency that is different from the first frequency and the signal processor acquires the command based on whether the first frequency and the second frequency satisfy one other predetermined relationship.

In one example, in the above robot and the robot control system, the command comprises a starting bit and at least one command bit. In addition, the signal processor outputs the starting bit when detecting that the first frequency lasts for a first period. The signal processor outputs the command bit with a first logic value when detecting that the first frequency lasts for a second period and the second frequency lasts for a third period. The signal processor outputs the command bit with a second logic value when detecting that the first frequency lasts for a fourth period and the second frequency lasts for a fifth period. The first logic value is different from the second logic value.

In one example, according to the invention, a plurality of robots can be simultaneously controlled and the robots can execute a variety of motions. In one example, the robots can be controlled to execute designated motions even under the condition of having background music, preferably to execute designated motions in harmony with the background music. In one example, the robots can be disposed at any position apart from the loud-speaker with a proper distance with no wire interference and being convenient in use.

### BRIEF DESCRIPTION OF THE DRAWINGS

FIG. 1 shows a schematic diagram illustrating the robot according to one embodiment of the invention and the functional block diagrams thereof.

FIG. 2 shows a schematic diagram illustrating the robot control system according to one embodiment of the invention.

FIG. 3 shows a loudness-frequency curve illustrating auditory threshold.

FIG. 4 shows a functional block diagram illustrating the robot control system according to another embodiment of the invention.

FIG. 5 shows a schematic diagram illustrating the robot control system according to another embodiment of the invention.

FIG. 6 shows a functional block diagram illustrating the robot control system according to another embodiment of the invention.

FIG. 7 shows a conventional toy and the functional block diagram thereof.

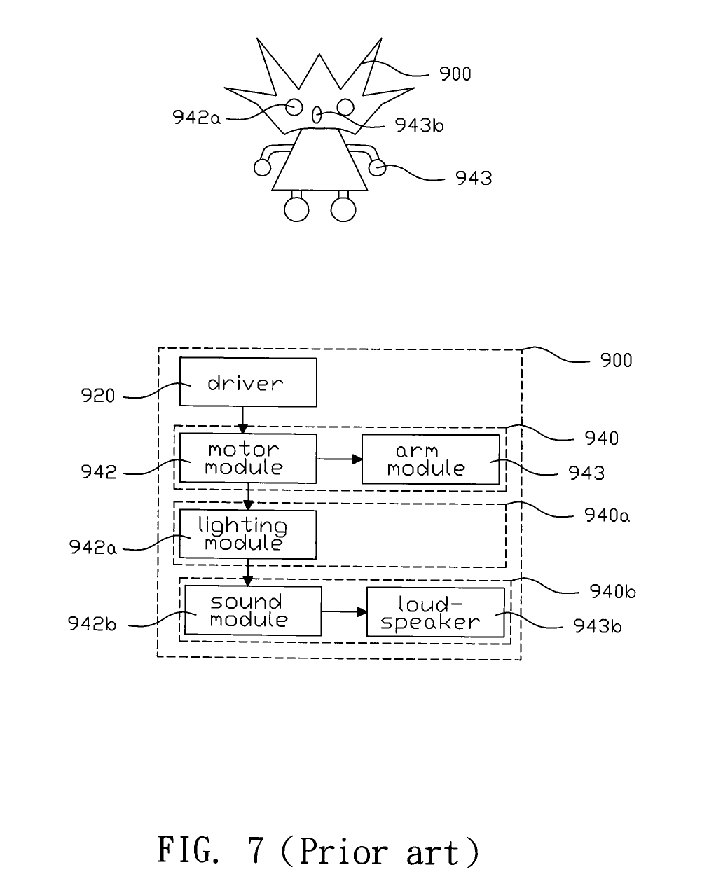

### DETAILED DESCRIPTION OF THE INVENTION

The above and other technical content, characteristics, functions of the invention will be described in details with reference to the drawings. For clarity, the wording related to direction, such as up, down, left, right, front, back, etc., used in examples is referred to the direction in drawings. Therefore, the wording related to direction is not used to limit the scope of the invention.

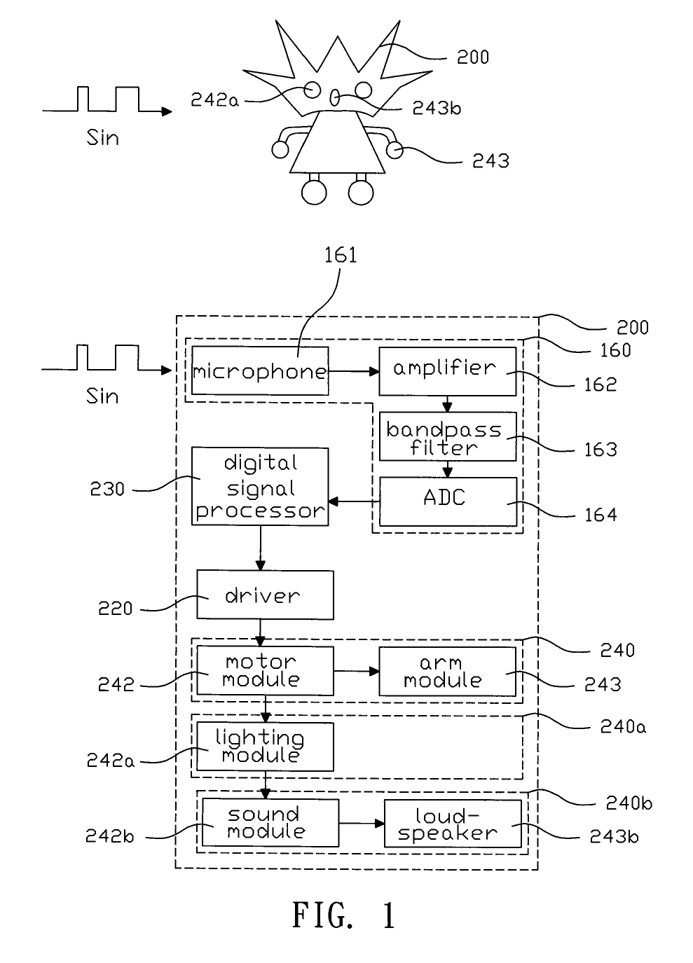

FIG. 1 shows a schematic diagram illustrating the robot according to one embodiment of the invention and the functional block diagrams thereof. Referring to FIG. 1, the robot 200 is suitable for receiving an input signal Sin to generate a response. The input signal Sin can be an audio signal produced by a loud-speaker (not shown in the figure) and a tone St is mixed in the audio signal. The audio signal is planted with a command and the input signal Sin can also comprise the background sound like voice in the environment where the robot 200 is placed. The robot 200 includes a receiver 160, a digital signal processor 230, a driver 220 and a response device 240. The receiver 160 can comprise a microphone 161, an amplifier 162, a bandpass filter 163, and an analog-to-digital converter (ADC) 164. The microphone 161 can be an electric condenser microphone (ECM) for receiving the input signal Sin. The amplifier 162 is provided to amplify the input signal Sin received by the microphone 161 since occasionally the amplitude of the input signal Sin received by the microphone 161 is too weak or the characteristic of the microphone 161 results in the output signal being too weak. As the input signal Sin is the sound and tone produced by the loud-speaker, the input signal Sin is an analog signal. Since the digital signal processor 230 processes digital signals, the analog-to-digital converter 164 is provided between the microphone 161 and the digital signal processor 230 to convert the analog input signal Sin into a digital input signal Sin. In addition, the bandpass filter 163 can be provided between the amplifier 162 and the analog-to-digital converter 164. In one example, the frequency of the tone St can be set to be higher than 16 kHz. The background sound, including the sound in the environment where the robot 200 is placed, generally is lower than 16 kHz. Therefore, the bandpass filter 163 can substantially filter the background sound in advance to increase the accuracy of detecting the command of the tone of the input signal Sin by the robot 200.

The digital signal processor 230 analyzes the tone St of the input signal Sin to acquire the command in the tone St. In one example according to the invention, the tone St has a first frequency like 18 kHz and a second frequency that is different from the first frequency like 20 kHz. Thus, the digital signal processor 230 acquires the command by determining whether the first frequency and the second frequency satisfy a predetermined relationship. Specifically, the relationship is the relation between frequency and time, such as ladder type relation. In one example, the command comprises a starting bit and four command bits. During operation, the receiver 160 receives the input signal Sin in real time. Thus, the digital signal processor 230 also receives the digital input signal Sin in real time and analyzes the tone St in the input signal Sin. When the digital signal processor 230 detects that the first frequency lasts for a first period, it outputs the starting bit. When the digital signal processor 230 detects that the first frequency lasts for a second period and the second frequency lasts for a third period, it outputs the command bit with logic 1. When the digital signal processor 230 detects that the first frequency lasts for a fourth period and the second frequency lasts for a fifth period, it outputs the command bit with logic 0. The starting bit is set to be with no logic value and is for identification only. Before the digital signal processor 230 detects the starting bit, no command bit is outputted in order to guarantee the correctness and completeness of the command. When the digital signal processor 230 detects that the starting bit is outputted and the number of the outputted command bits meets a preset number (four in this example), the digital signal processor 230 determines that the command is complete and outputs this command.

TABLE 1

| Command | | Tone |
|---|---|---|
| Starting bit | | Frequency 18 kHz lasting for 0.09 sec |
| Command bit | Logic 1 | Frequency 18 kHz lasting for 0.03 sec |
| | | and Frequency 20 kHz lasting for 0.06 sec |
| Command bit | Logic 0 | Frequency 18 kHz lasting for 0.06 sec |
| | | and Frequency 20 kHz lasting for 0.03 sec |

Referring to Table 1, in this example, the second period is equal to the fifth period, about 0.03 second, the third period is equal to the fourth period, about 0.06 second, and the first period is equal to the sum of the second period and the third period, about 0.09 second. Therefore, a complete command takes 0.45 second. Since the starting bit and the command bit are set to last for a same period of time, 0.09 second in this example, the digital signal processor 230 determines that no any command is detected or the command is incorrect when the digital signal processor 230 cannot detect a tone beyond a preset period of time like 0.09 second. In addition, the digital signal processor 230 waits for the next starting bit without outputting any command bit. Therefore, the operation of the digital signal processor 230 can be simplified and the error in outputting the command can be reduced.

The response device 240 receives this command and thereby generates a response. In this embodiment, the response can be an arm motion. The driver 220, electrically coupling between the response device 240 and the digital signal processor 230, generates an operating signal according to the command outputted by the digital signal processor 230. The response device 240 can comprise a motor module 242 and an arm module 243 connected to the motor module 242. The driver 220 drives the motor module 242 to have the arm module 243 execute a motion, such as hand-waving or knocking, while receiving the command from the digital signal processor 230. In another example, a motion module capable of executing a motion can be used to replace the arm module 243. For example, a foot module for advancing steps or an eye module for blinking eyes can be used to replace the arm module 243. That is, an actuating mechanism can be used. In one example, the response device 240a may be a lighting module 242a and the response is the variation of the light from the lighting module 242a. In one example, the response device 240b may comprise a sound module 242b and the loud-speaker 243b and the response is the different sound produced by the loud-speaker 243b.

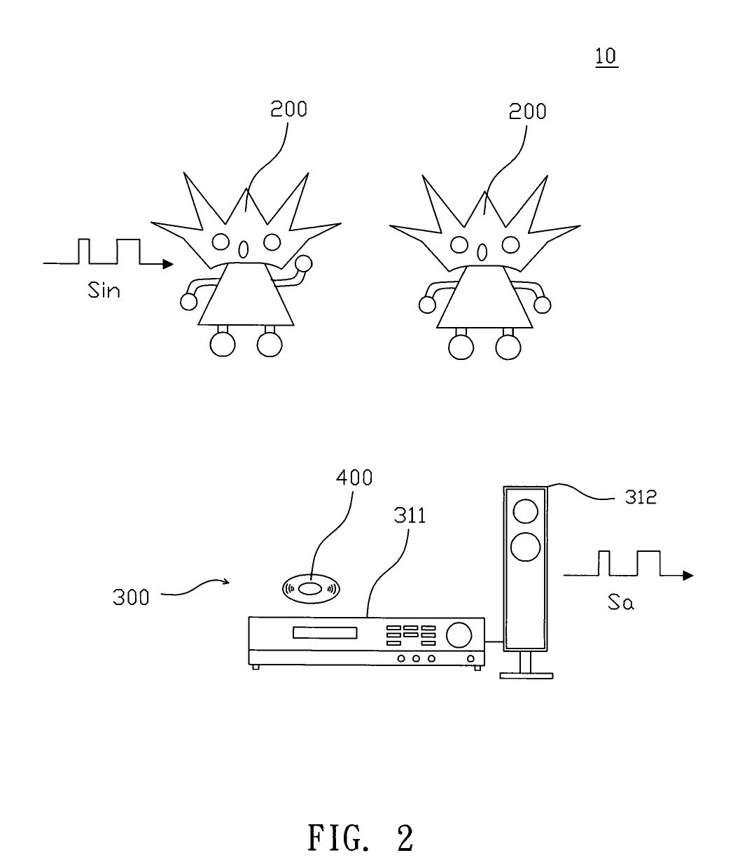

FIG. 2 shows a schematic diagram illustrating the robot control system according to one embodiment of the invention. Referring to FIG. 2, the robot control system 10 comprises at least one robot 200, a storage unit 400, and a playing device 300. In this embodiment, the number of the robots 200 is two. The robot 200 in this embodiment is similar to that shown in FIG. 1. Therefore, the same notation is used for the same element and the same element will not be described hereafter. The storage unit 400 stores at least one audio signal Sa. The audio signal Sa comprises a tone St. The tone St has a command and comprises a first frequency and a second frequency that is different from the first frequency. The playing device 300 comprises a loud-speaker 311 and a playing unit 312. The playing unit 312 accesses the audio signal Sa and plays the audio signal Sa via the loud-speaker 311. The playing unit 312 plays the audio signal Sa and plays the tone St in the audio signal Sa as well to have the audio signal Sa be mixed with the tone St. The audio signal Sa and the background sound in the environment where the robot 200 is placed are mixed to form the input signal Sin. In addition, in the tone St, a period to playing the first frequency, such as 18 kHz, and a period to playing the second frequency, such as 20 kHz, can be provided. That is, a command can be provided in the tone St to have the tone Sa, after playing the audio signal Sa, comprise this command. It should be understood that the audio signal can be the tone St itself or can comprise a sound, such as background music, and the tone St. The receiver 160 of the robot 200 can comprise a bandpass filter 163 to somewhat filter the background music in the input signal Sin.

In one example, the playing device 300 is an optical disc player and the storage unit 400 is a digital versatile disc (DVD) or a compact disc (CD). Video data or audio data can be stored in the digital versatile disc (DVD) or a compact disc (CD) to be accessed and played by the playing device 300. Moreover, the compact disc (CD) can be an audio disc comprising one or more than one stereo tracks encoded by 16 bit PCM with a sampling rate of 44.1 Hz. The data stored in these discs also comprise the audio signal Sa and this audio signal Sa comprises the background music and the tone St. Obviously, in another example, the playing unit 311 of the playing device 300 can be a mobile player and the storage unit 400 can be flash memory.

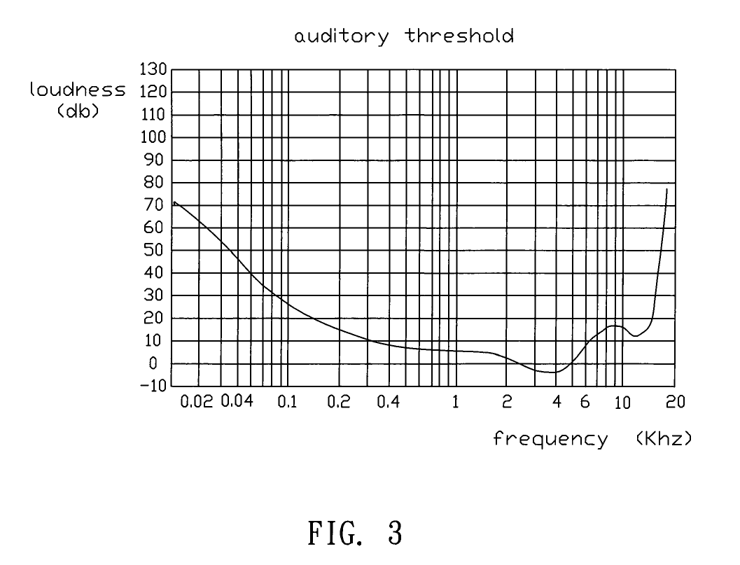

FIG. 3 shows a loudness-frequency curve illustrating auditory threshold. As shown in FIG. 3, when the frequency of sound is 1 kHz, a loudness of 7 db can be even heard. When the frequency of sound is 20 kHz, the loudness needs 70 db to be heard. Therefore, the first frequency and the second frequency of the tone St in the audio signal Sa can be set to have higher frequencies so that interfering the tone will be reduced while listening music. The frequency of the background music can be set to be lower than 16 kHz, preferably lower than 10 kHz, more preferably lower than 5 kHz. The first frequency and the second frequency of the tone St can be set to be higher than or equal to 16 kHz, separately. Preferably, the first frequency is set to 18 kHz and the second frequency is set to 20 kHz.

Furthermore, the robot control system 10 can simultaneously control a plurality of robots 200. In this embodiment, a command is set to have one starting bit and four command bits. Each command bit can be either logic 1 or logic 0. Therefore, 2⁴ commands can be generated. For example, in the robot control system 10, the first two command bits can be designated to indicate which robot is to execute a response (motion, lighting or generating sound, etc.) and the rest two command bits can be designated to indicate which response is to be executed. Therefore, a command with four command bits can control four robots 200 to execute four types of responses. If the number of the command bits is set to eight, 8 robots 200 can be controlled to execute 8 types of responses. Other cases can be reasoned by analogy.

In one example, the robot control system 10 and the robots 200 can be assembled to build a set of toy orchestras. The set of toy orchestras can be controlled by the specially-made digital versatile disc (DVD) or a compact disc (CD). Usually the orchestra includes a guitar player, a drum player, a keyboard player, a bass player, etc. When the disc is played, these toys can be controlled by the command in the audio signal Sa in the disc to execute the appropriate action. Therefore, the whole action of these toys can be very fruitful. When the background music of the audio signal is rock-and-roll music, these toys can execute the motions in harmony with the rock-and-roll music. When background music of the audio signal is lyric music, these toys can execute the motions in harmony with the lyric music. Thus, a user just needs to change music to increase the attractiveness and the degree of entertainment of the toys.

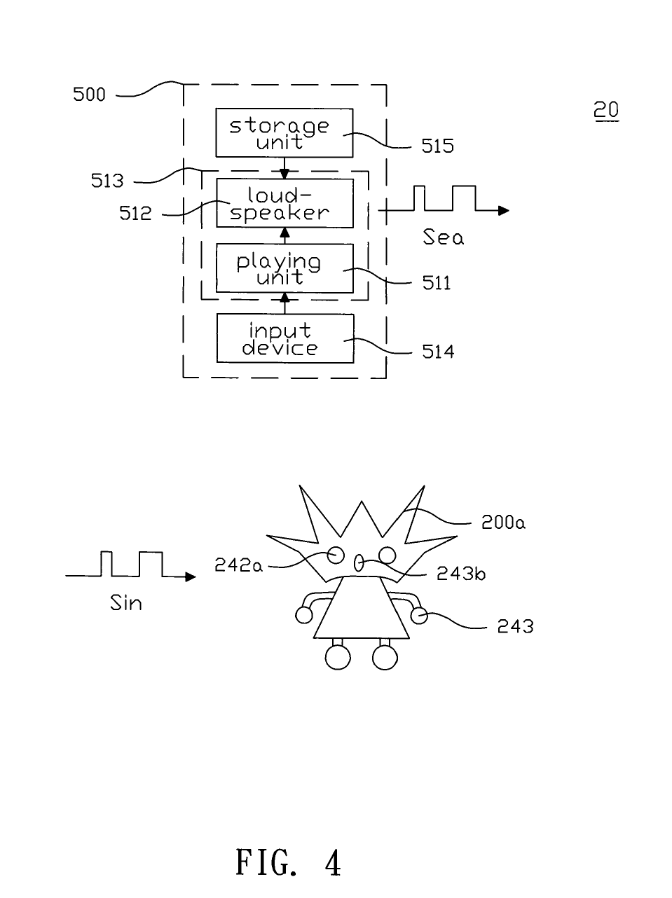

FIG. 4 shows a functional block diagram illustrating the robot control system according to another embodiment of the invention. As shown in FIG. 4, the robot control system 20 comprises at least one robot 200a and a first server 500. The first server 500 includes an input device 514, a storage unit 515, and a tone processing unit 513. The tone processing unit 513 comprises a playing unit 511 and a loud-speaker 512. The storage unit 515 stores a plurality of audio signals Sa. Each audio signal comprises a tone St. Each tone St contains a different command, such as having the robot 200a execute smiling or hand-raising. The input device 514 is used to input a control datum. The control datum can be a word, such as “smile” or “hand-raising”. The tone processing unit 513 analyzes the relation between the control datum and the commands in these tones to generate a selecting audio signal Sea corresponding to the control datum. Specifically, the tone processing unit 513 analyzes the control datum and selects the audio signal Sa that has the command corresponding to the control datum, among these audio signals Sa, for being played by the playing unit 511 via the loud-speaker 512. For example, as the control datum is the word “smile”, the tone processing unit 513 analyzes this control datum and recognizes the meaning of “smile”. Then, the tone processing unit 513 selects the audio signal Sa having the command “smile” to generate a selecting audio signal Sea. More specifically, the selecting audio signal Sea comprises a tone St and the tone St has the command to request the robot 200a to smile while the playing unit 511 of the tone processing unit 513 plays the selecting audio signal Sea via the loud-speaker 512. It should be understood that the selecting audio signal Sea can be the tone St itself or can comprise the background music and the tone St. The robot 200a in this embodiment is similar to that shown in FIG. 1. Therefore, the same notation is used for the same element and the same element will not be described hereafter. After the robot 200a receives the selecting audio signal Sea and analyzes the selecting audio signal Sea to acquire the smile command, the robot 200a executes smiling action. After the robot 200a executes smiling action, laughter can be uttered via the sound module 242b and the loud-speaker 243b. In addition, a second tone can be uttered by the robot 200a to request the other robot 200a to execute one other action, such as clapping hands so that one robot 200a can control the other robot 200a.

In one example, the invention can be applied in language learning. The input device 514 can be a keyboard. A user can use foreign language like English to enter the control datum. For example, when the user enters the word “smile”, the robot control system 20 analyzes the correctness of spelling. If the spelling is correct, the robot control system 20 generates the audio signal Sa comprising the tone having the smile command. After the robot 200a receives the tone having the smile command, it utters laughter or pronounces the English word “smile”. If the spelling is incorrect, the tone of showing incorrect spelling is uttered. For example, after the tone having the hand-raising command is received by the robot 200a, the robot 200a executes hand-raising action and can also pronounce correct spelling to assist the user in leaming.

In one example, the input device 514 can be implemented by a central processor unit (CPU) and programs. For example, the input device 514 can couple to mail software. When the mail software receives a mail, a control datum is sent. After the robot control system 20 receives the control datum via the input device 514, the robot control system 20 generates the tone having the smile command to request the robot 200a to utter laughter to remind the user of reading the mail.

Furthermore, the input device 514 can be a server. The control datum is a mail or message downloaded from the server. The robot 200a executes a response according to the content of the mail or message.

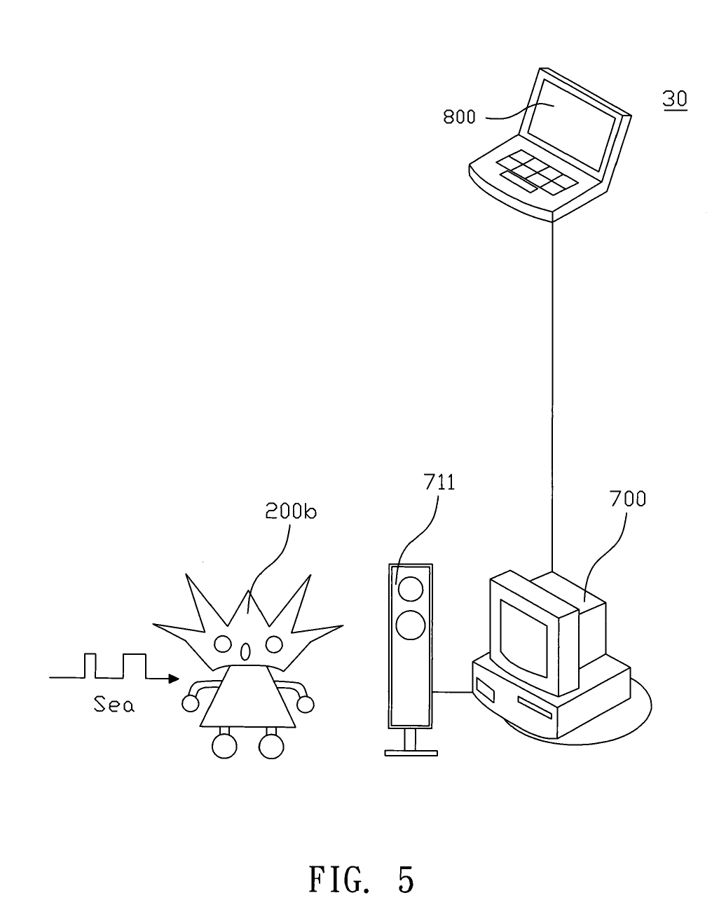

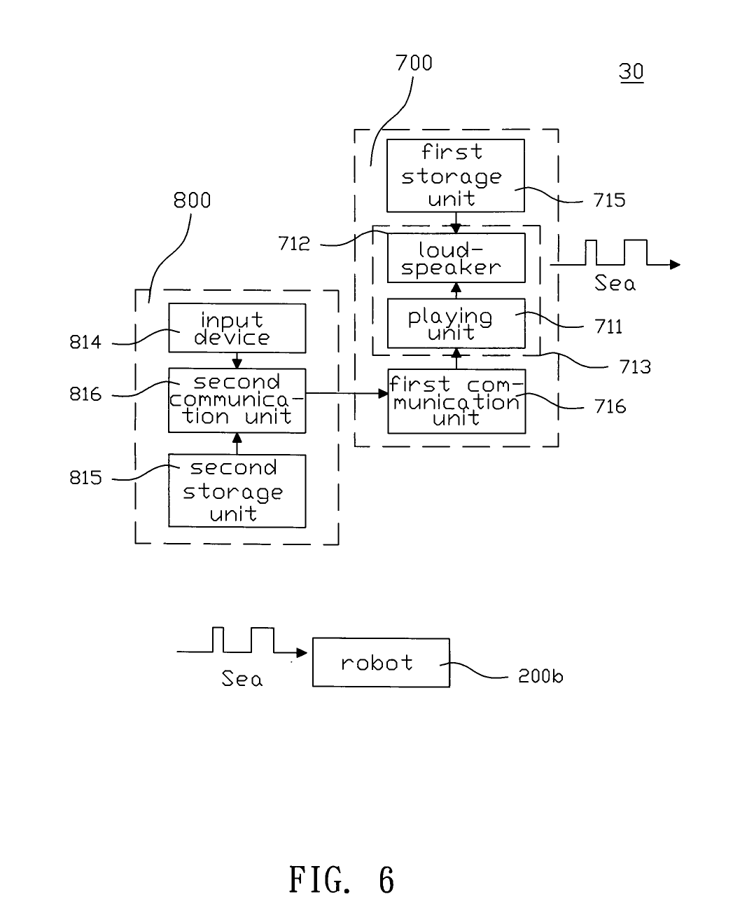

FIG. 5 shows a schematic diagram illustrating the robot control system according to another embodiment of the invention. FIG. 6 shows a functional block diagram illustrating the robot control system according to another embodiment of the invention. As shown in FIG. 5 and FIG. 6, the robot control system 30 comprises at least one robot 200b, a first server 700, and a second server 800. The first server 700 couples to the second server 800 and comprises a first storage unit 715, a first communication unit 716 and a tone processing unit 713. The tone processing unit 713 comprises a playing unit 711 and a loud-speaker 712. The second server 800 comprises an input device 814, a second communication unit 816, and a second storage unit 815. The first storage unit 715 couples to the second storage unit 815 via the first communication unit 716 and the second communication unit 816.

In one example, a plurality of audio signals Sa are stored in the second storage unit 815. Each audio signal Sa comprises a tone St. Each tone St comprises one different command. For example, the command can request the robot 200b to smile or raise a hand or hands. The input device 814 of the second server 800 is used to input a control datum. The control datum can be a word, such as “smile” or “hand-raising”. After the tone processing unit 713 of the first server 700 receives the control datum from the second server 800 via the first communication unit 716 and the second communication unit 816, the tone processing unit 713 analyzes the control datum and selects the audio signal Sa having the command corresponding to this control datum among the plurality of audio signals Sa as the selecting audio signal Sea. In addition, the selecting audio signal Sea is downloaded to the first storage unit 715 for being played by the playing unit 711 via the loud-speaker 712. More specifically, the selecting audio signal Sea comprises a tone St and the tone St has the command to request the robot 200a to smile. It should be understood that the selecting audio signal Sea can be the tone St itself or can comprise the background music and the tone St. The robot 200b in this embodiment is similar to that shown in FIG. 1. Therefore, the same notation is used for the same element and the same element will not be described hereafter. After the robot 200b receives the selecting audio signal Sea and analyzes the selecting audio signal Sea to acquire the smile command, the robot 200b executes smiling action.

In one example, the first server 700 and the second server 800 individually can be a personal computer connected to Internet and the first communication unit 716 and the second communication unit 816 can be real-time communication software. When a user operating the second server 800 can send a message to another user operating the first server 700 via the first communication unit 716 and the second communication unit 816, the robot 200b can execute a response corresponding to this message. If the audio signal Sa corresponding to this control datum is not stored in the first storage unit 715, the robot 200b can select the audio signal Sa corresponding to this control datum from the second storage unit 815 via the first communication unit 716 and the second communication unit 816 as the selecting audio signal Sea and have the selecting audio signal Sea be downloaded to the first storage unit 715.

Since the robot control system 30 utilizes a common loud-speaker to use a tone to control the robot 200b. The robot 200b does not need to be connected to the first server 700. Therefore, the specially-made hardware does not need to be installed in the first server 700. The robot 200b can be disposed at any position apart from the loud-speaker with a proper distance with no wire interference and being convenient in use.

Although the present invention has been fully described by the above embodiments, the embodiments should not constitute the limitation of the scope of the invention. Various modifications or changes can be made by those who are skilled in the art without deviating from the spirit of the invention. Therefore, the scope of the invention is based on the appended claims and it should be accorded the broadest interpretation so as to encompass all such modifications and similar arrangements. One embodiment or claim does not have to encompass all the merits of the invention. Besides, the abstract and the title of the invention are for assisting in search, but not for constituting the limitation of the scope of the invention.

What is claimed is:

1. A robot, suitable for receiving an input signal to generate a response where the input signal includes a tone that comprises a first frequency, the robot comprising:
a receiver for receiving the tone of the input signal;
a signal processor for acquiring a command by determining whether the first frequency satisfies a predetermined relationship;
a driver for generating an operating signal according to the command; and
a response device for receiving the operating signal and thereby generating the response according the operating signal.

2. The robot according to claim 1, wherein the tone further comprises a second frequency that is different from the first frequency and the signal processor acquires the command based on whether the first frequency and the second frequency satisfy another predetermined relationship.

3. The robot according to claim 1, wherein the response device comprises a motor module and an actuating mechanism connected to the motor module and the response is the different action generated by the actuating mechanism.

4. The robot according to claim 1, wherein the response device comprises a lighting module and the response is the variation of the light from the lighting module.

5. The robot according to claim 1, wherein the response device comprises a sound module of a loud-speaker and the response is the different sound produced by the loud-speaker.

6. The robot according to claim 2, wherein
the command comprises a starting bit and at least one command bit;
the signal processor outputs the starting bit when detecting that the first frequency lasts for a first period; the signal processor outputs the command bit with a first logic value when detecting that the first frequency lasts for a second period and the second frequency lasts for a third period; and the signal processor outputs the command bit with a second logic value when detecting that the first frequency lasts for a fourth period and the second frequency lasts for a fifth period; where the first logic value is different from the second logic value.

7. The robot according to claim 6, wherein the second period equals the fifth period, the third period equals the fourth period, and the first period equal the sum of the second period and the third period.

8. The robot according to claim 1, wherein the first frequency and the second frequency are higher than or equal to 16 kHz, separately.

9. The robot according to claim 1, wherein the input signal further comprises a sound and the frequency of the sound is less than the first frequency and the second frequency, separately.

10. The robot according to claim 1, wherein the signal processor is a digital signal processing device and the receiver comprises:
a microphone for receiving the input signal;
an amplifier for amplifying the input signal received by the receiver;
a bandpass filter for filtering at least one part of the sound in the input signal; and
an analog-to-digital converter for converting the input signal into a digital signal.

11. A robot control system using a tone, the system comprising:
a storage unit for storing at least one audio signal that includes the tone comprising a first frequency;
a playing device for accessing the audio signal and playing the audio signal;
a receiver for receiving the tone of the audio signal;
a signal processor for acquiring a command by determining whether the first frequency satisfies a predetermined relationship;
a driver for generating an operating signal according to the command; and
a response device for receiving the operating signal and thereby generating a response according the operating signal;
wherein the response is substantially related to the content of the audio signal.

12. The system according to claim 11, wherein the tone further comprises a second frequency that is different from the first frequency and the signal processor acquires the command based on whether the first frequency and the second frequency satisfy one other predetermined relationship.

13. The system according to claim 12, wherein
the command comprises a starting bit and at least one command bit;
the signal processor outputs the starting bit when detecting that the first frequency lasts for a first period; the signal processor outputs the command bit with a first logic value when detecting that the first frequency lasts for a second period and the second frequency lasts for a third period; and the signal processor outputs the command bit with a second logic value when detecting that the first frequency lasts for a fourth period and the second frequency lasts for a fifth period; where the first logic value is different from the second logic value.

14. The system according to claim 13, wherein the audio signal further comprises a sound; the frequency of the sound is less than the first frequency and the second frequency, separately; and the first frequency and the second frequency are higher than or equal to 16 kHz, separately.

15. The system according to claim 11, wherein the storage unit is an optical disc and the playing device is an optical disc player.

16. A robot control system, comprising:
an input device for inputting a control datum;
a storage unit for storing a plurality of audio signals that are all different wherein each audio signal comprises a tone and each tone is provided with a command and comprises a first frequency; and
a tone processing unit for analyzing the relation between the control datum and the commands in the tones to generate a selecting audio signal corresponding to the control datum;
a receiver for receiving the selecting audio signal;
a signal processor for acquiring the command of the selecting audio signal by determining whether the first frequency satisfies a predetermined relationship;
a driver for generating an operating signal according to the command of the selecting audio signal; and
a response device for receiving the operating signal and thereby generating a response according the operating signal.

17. The system according to claim 16, wherein the tone further comprises a second frequency that is different from the first frequency and the signal processor acquires the command based on whether the first frequency and the second frequency satisfy another predetermined relationship.

18. The system according to claim 16, wherein the input device is a keyboard.

19. The system according to claim 18, wherein the control datum is a character or a symbol inputted by the keyboard.

20. The system according to claim 16, wherein the input device is a server.

21. The system according to claim 20, wherein the control datum is a mail or message downloaded from the server.

22. The system according to claim 16, wherein the tone processing unit further comprises a playing unit and a loud-speaker and the playing unit plays the selecting audio signal via the loud-speaker.

23. The system according to claim 17, wherein
the command comprises a starting bit and at least one command bit;
the signal processor outputs the starting bit when detecting that the first frequency lasts for a first period; the signal processor outputs the command bit with a first logic value when detecting that the first frequency lasts for a second period and the second frequency lasts for a third period; and the signal processor outputs the command bit with a second logic value when detecting that the first frequency lasts for a fourth period and the second frequency lasts for a fifth period; where the first logic value is different from the second logic value.
